(19) United States
(12) Patent Application Publication
(10) Pub. No.: US 2026/0267877 A1
(43) Pub. Date: Sep. 10, 2026

(54) TIME SERIES MODEL FOR MULTIVARIATE FORECASTING

(71) Applicant: JPMorgan Chase Bank, N.A., NEW YORK, NY (US)

(72) Inventors: Manoj Cherukumalli, San Jose, CA (US); Harshsaiprasad Saiprasan Deshpande, Santa Clara, CA (US); Amit Varshney, Fremont, CA (US); Naren Chittar, Saratoga, CA (US); Leonard Eun, Lafayette, CA (US); Prathamesh Patil, East Palo Alto, CA (US); Dushyant Sahoo, Foster City, CA (US)

(73) Assignee: JPMorgan Chase Bank, N.A., NEW YORK, NY (US)

(21) Appl. No.: 19/075,477

(22) Filed: Mar. 10, 2025

(51) Int. Cl. G06F 16/28

(52) U.S. Cl. CPC G06F 16/285

(57) ABSTRACT

In accordance with one or more embodiments, one or more apparatus are provided. Storage is provided which is encoded with a given plural set of features and given one or more target vectors associated with and related to the given set of features, based on time-series data. A learning model comprising a transformer module may be provided to perform time-series forecasting with tokenization. An input processing circuit is provided that comprises an interleaver configured to interleave feature and target model space tokens representing and converted from the given plural set of features and the given one or more target vectors, with separator tokens, to form a flattened series of tokens, wherein the input processing circuit is configured to input the flattened series of tokens to the transformer module. An output processing circuit is provided which is configured to select a given one or more predicted target model tokens.

### FIELD OF THE DISCLOSURE

Aspects of the present disclosure relate to time series forecasting. More specifically, aspects of the present disclosure relate to systems for performing multivariate time series forecasting.

### BACKGROUND

Time series forecasting systems provide predictions of events and when they are likely to occur. Models are trained on historical data, and then employed to provide the predictions. Univariate time series forecasting models predict a sequence of values of the same features over time, while multivariate time series forecasting models predict future target values based on multiple features. Forecasting models, generally statistical or machine learning-based, are typically tailored to specific use cases, leaving the need for forecasting models for numerous other use cases.

### SUMMARY

An objective of the present disclosure is to provide a large-scale model capable of performing time series forecasting for a wide range of use cases. A further objective of the present disclosure is to provide a large-scale zero-shot model capable of performing time series forecasting for a wide range of use cases. Yet another objective of the present disclosure is to provide a large-scale model capable of performing multivariate time series forecasting of benchmark events for a wide range of use cases.

Another objective of the present disclosure is to provide data gathering and generation approaches supporting a large-scale model capable of performing multivariate time series forecasting of benchmark events for a wide range of use cases. Other or alternative objectives may be apparent from the following disclosure.

Embodiments of the disclosure include any apparatus, machine, system, method, articles (e.g., computer-readable media encoded to cause certain acts), or any one or more sub-parts or sub-combinations of such apparatus (singular or plural), system, method, or article (or encoding thereon or therein), for example, as supported by the present disclosure. Embodiments herein also contemplate that any one or more processes as described herein may be incorporated into a processing circuit as defined herein.

In accordance with one or more embodiments, one or more apparatus are provided. Storage is provided which is encoded with a given plural set of features and given one or more target vectors associated with and related to the given set of features, based on time-series data. A learning model comprising a transformer module may be provided to perform time-series forecasting with tokenization. An input processing circuit is provided that comprises an interleaver configured to interleave feature and target model space tokens representing and converted from the given plural set of features and the given one or more target vectors, with separator tokens, to form a flattened series of tokens, wherein the input processing circuit is configured to input the flattened series of tokens to the transformer module. An output processing circuit is provided which is configured to select a given one or more predicted target model tokens from an output token probability distribution output by the transformer module.

The transformer module may comprise encoder and decoder stacks. More specifically, the transformer module may comprise a T5 transformer, or a T5-small transformer.

The separator tokens may comprise at least one feature separator token inserted in the flattened series at a location associated with one or more of the feature model space tokens and at least one target separator token inserted in the flattened series at a location associated with one or more of the given target model space tokens.

Per one embodiment of a method, storage is encoded with a given set of features and one or more target vectors associated with and related to the given set of features, based on time-series data. A prediction model is operated that comprises a transformer module to perform time-series forecasting with tokenization. Input processing is performed comprising interleaving feature and target model space tokens representing and converted from the given plural set of features and the one or more target vectors, with separator tokens to form a flattened series of tokens. Output processing is performed comprising selecting a given one or more predicted target model tokens from an output token probability distribution output by the transformer module.

Per another example embodiment, non-transitory computer-readable media is provided, that is encoded to cause encoding storage with a given set of features and one or more target vectors associated with and related to the given set of features, based on time-series data. In addition, a prediction model is operated that comprises a transformer module to perform time-series forecasting with tokenization. Input processing is performed comprising interleaving feature and target model space tokens representing and converted from the given plural set of features and the one or more target vectors, with separator tokens to form a flattened series of tokens. The flattened series of tokens is input to the transformer module. Output processing is performed comprising selecting a given one or more predicted target model tokens from an output token probability distribution output by the transformer module.

Additional features, modes of operations, advantages, and other aspects of various embodiments are described below with reference to the accompanying drawings. It is noted that the present disclosure is not limited to the specific example embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only example embodiments of this disclosure and are therefore not to be considered limiting of its scope. For example, the disclosure may admit to other embodiments.

FIG. 1 is a block diagram of an embodiment of a multivariate forecasting system;

FIG. 2 is a block diagram of a predictive model system;

FIG. 3 is a schematic diagram illustrating input data structures for the illustrated model system;

FIG. 4 is a flowchart of one example embodiment of an interleave process carried out on the input data, for example, as shown in FIG. 3;

FIG. 5 is a flowchart of an example embodiment of a data generation process; and

FIG. 6 is a block diagram of a computer controller system per one embodiment.

To facilitate understanding, identical reference numerals may be used to designate identical or like elements in the figures. It is contemplated that elements disclosed in one embodiment may be beneficially utilized in other embodiments without specific recitation.

### DETAILED DESCRIPTION

In the following, reference is made to example embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure.

Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim.

In accordance with one or more embodiments herein, various terms may be defined as follows.

Application or application program. An application program is a program that, when executed, performs a task for another program or user, whereas an operating system program, when executed, serves as an interface between an application program and the underlying hardware of a computer. Any one or more of the various acts described below may be carried out by a program, e.g., an application program and/or operating system program.

Processing circuit. A processing circuit (or circuit) may include both (at least a portion of) non-transitory computer-readable media carrying functional encoded data and components of an operable computer. The operable computer is capable of executing (or is already executing) the functionally encoded data and thereby is configured when operable to cause certain acts to occur. A processing circuit may also include: a machine or part of a machine that is specially configured to carry out a process, for example, any process described herein; or a special purpose computer or a part of a special purpose computer.

A processing circuit may also be in the form of a general-purpose computer running a compiled, interpretable, or compilable program (or part of such a program) that is combined with hardware carrying out a process or a set of processes. A processing circuit may further be implemented in the form of an application-specific integrated circuit (ASIC), part of an ASIC, or a group of ASICs. A processing circuit may further include an electronic circuit or part of an electronic circuit. A processing circuit does not exist in the form of code per se, software per se, instructions per se, mental thoughts alone, or processes that are carried out manually by a person without any involvement of a machine.

Program: A program includes software for a processing circuit.

User interface tools; user interface elements; output user interface; input user interface; input/output user interface; and graphical user interface tools. User interface tools are human user interface elements that allow human user and machine interaction, whereby a machine communicates to a human (output user interface tools), a human inputs data, a command, or a signal to a machine (input user interface tools), or a machine communicates, to a human, information indicating what the human may input, and the human inputs to the machine (input/output user interface tools). Graphical user interface tools (graphical tools) include graphical input user interface tools (graphical input tools), graphical output user interface tools (graphical output tools), and/or graphical input/output user interface tools (graphical input/output tools).

A graphical input tool is a portion of a graphical screen device (e.g., a display and circuitry driving the display) configured to, via an on-screen interface (e.g., with a touchscreen sensor, with keys of a keypad, a keyboard, etc., and/or with a screen pointer element controllable with a mouse, toggle, or wheel), visually communicate to a user data to be input and to visually and interactively communicate to the user the device's receipt of the input data.

A graphical output tool is a portion of a device configured to, via an on-screen interface, visually communicate to a user information output by a device or application. A graphical input/output tool acts as both a graphical input tool and a graphical output tool. A graphical input and/or output tool may include, for example, screen-displayed icons, buttons, forms, or fields. Each time a user interfaces with a device, program, or system in the present disclosure, the interaction may involve any version of a user interface tool as described above, e.g., which may be a graphical user interface tool.

The embodiments herein may also involve wearable devices or elements, a neurological system interfacing with a device, human-machine integration, and human-machine hybrid technology.

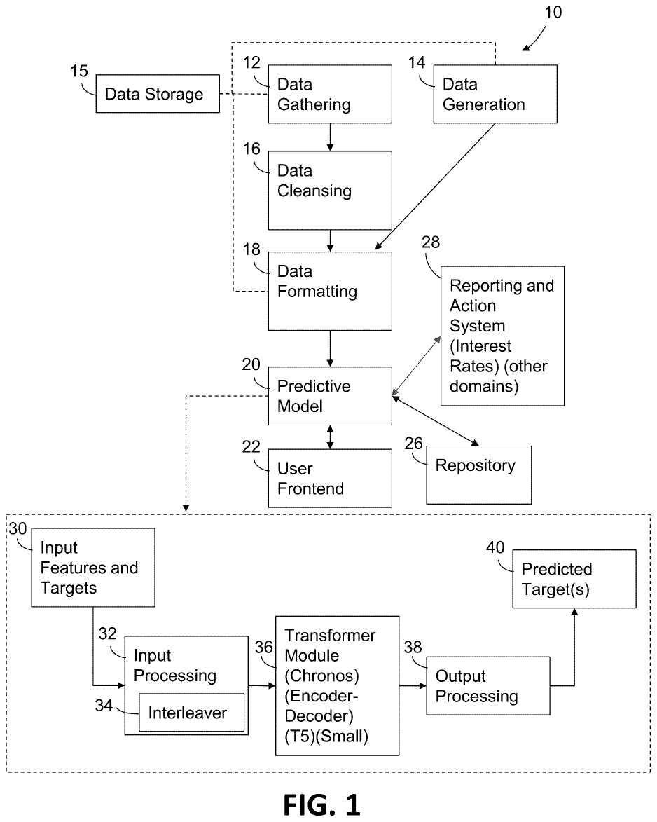

Referring to the drawings in greater detail, FIG. 1 shows a multivariate forecasting system 10. The illustrated system 10 includes a number of pre-model portions, including a data gathering processing circuit 12, a data generation processing circuit 14, a data cleansing processing circuit 16, a data formatting processing circuit 18, and data storage 15.

Data storage 15 comprises media encoded with various data, for example, including proprietary time-series data and open-source time-series data, each gathered by data gathering processing circuit 12. Data storage 15 may further comprise media encoded with data generated by data generation processing circuit 14, that is, synthetic time-series data that was synthetically generated, for example, as further described below.

Data cleansing processing circuit 16 is provided to sample features from one or more databases and perform data cleansing on the sampled feature data. The samples may be obtained using bootstrap sampling, as an example. The data may be cleaned so that it is easily understood by either a human or a machine. Cleaning may be done with an automated process, or it may be done manually, or with a combination of automated processing and human input.

Data formatting processing circuit 18 is provided to format the cleaned sampled data. The sampled features are put into an interim format helpful to the model in the machine learning that will be later performed, for example, as described below.

A predictive model 20 receives the data from data formatting processing circuit 18. As further described below, predictive model 20 is configured to carry out pretraining and fine-tuning when in a pretraining mode. The predictive model 20 is configured to carry out predictions when in an inference model. In an illustrated embodiment, model 20 is configured to carry out predictions with a zero-shot model capable of performing multivariate time series forecasting of benchmark events for a wide range of use cases.

A reporting and action system 28 may be provided that is configured to provide reports of predictions, and further configured to trigger actions associated with predictions provided by model 20. For example, system 28 may, upon the occurrence with a given prediction of an event happening in a certain time window and/or upon the occurrence of a target value being within a prescribed range, send a signal or communication to another system, or provide an indication to be logged in a database. The signal or communication may cause another system to carry out some action, for example, automatically, immediately, or in the future.

User frontend 22 may be operatively coupled with predictive model 20 and/or system 28 and may be provided with one or more user interface tools and associated applications. The user frontend 22 may allow a user to select a specific set of data for pretraining or input during inference by model 20, or for allowing feedback or modifications to model 20. Model 20 may employ one or plural predictive models, which may comprise machine learning systems.

Repository 26 may be provided for holding prediction data output by model 20.

Predictive model 20 may be implemented as shown in further detail toward the bottom of FIG. 1. Input features and targets 30 may be provided as input predictive model 20, while model 20 outputs one or more predicted targets 40. More specifically, storage may be provided (e.g., data storage 15) that is encoded with a given plural set of features and a given one or more target vectors associated with and related to the given set of features, based on time-series data. These input features and associated one or more targets 30 may be input to an input processing circuit 32, which provides data to a transformer module 36. Transformer module 36 then provides data to an output processing circuit 38, which outputs one or more predicted targets 40.

In the illustrated embodiment, input processing circuit 32 comprises an interleaver 34 that is configured to interleave feature and target model space tokens representing, and converted from, the given plural set of features and the given one or more target vectors. Separator tokens are used to form a flattened series of tokens. The input processing circuit is configured to input the flattened series of tokens to transformer module 36.

In the illustrated embodiment, output processing circuit 38 is configured to select a given one or more predicted target model tokens from an output probability distribution output by transformer module 36.

Per one embodiment, predictive model 20 may be configured with pretraining and a particular mode, for one or more specific use cases. For example, predictive model 20 may be employed for predicting interest rates. Reporting and action system 28 may be configured to produce reports and trigger actions based on interest rate predictions.

With reference to the example use case of interest rate prediction, multivariate prediction is performed. Unlike univariate forecasting, which only analyzes one feature such as a given type of interest rate, multivariate forecasting considers multiple features, for example, plural types of rates such as short-term, long-term, mortgage rates, corporate bond yields, and other types of rates, alongside other potential factors such as inflation, unemployment, geopolitical events, GDP (gross domestic product) growth, and stock market indices.

As shown in FIG. 1, predictive model 20 may comprise a transformer module 36, along with input and outputs as shown. Inputs include media-encoded input features and targets 30 and an input processing circuit 32. Outputs include an output processing circuit 38 and media-encoded one or more predicted targets 40. In the illustrated embodiment, input processing circuit 32 includes an interleaver 34. Transformer module 36 may be a transformer-type large language model comprising encoder and decoder stacks of blocks. More specifically, the model may be an encoder-decoder T5 model. For example, the model may be a chronos pretrained time series forecasting model. Per one embodiment, the model is a T5-small transformer model.

Predictive model 20 may be a transfer learning model that is first pre-trained on a data-rich task before being fine-tuned on a downstream task.

More specifically, model 20 may comprise a transformer architecture model. In the alternative, any model architecture which can take an input sequence of tokens and output a sequence of output tokens can be used. We can also use models based on the GPT (using decoder only transformer architecture), and/or other variants of encoder-decoder architecture like BART (Bidirectional and Auto-Regressive Transformers) may be implemented. Further information about these alternative models and model architectures is provided in the following papers (GPT3—https://arxiv.org/pdf/2005.14165, BART—https://arxiv.org/pdf/1910.13461).

Transformer module 36 may alternatively or in addition, be implemented in accordance with the disclosure provided by the paper entitled Chronos: Learning the Language of Time Series, authored by A. F. Ansari et al., published in Transactions on Machine Learning Research in October 2024, as described at page 9 of that paper. This paper, available at https://arxiv.org/abs/2043.07815, is hereby incorporated by reference in its entirety for purposes of its disclosed features, systems, processes, and algorithms. Raffel et al. further describes a transformer type model, in their paper entitled Exploring the limits of transfer learning with a unified text-to-text transformer, published in 2020 in The Journal of Machine Learning Research, 21(1): 5485-5551. This paper is hereby incorporated by reference in its entirety for purposes of its disclosed features, systems, processes, and algorithms.

Further information about the transformer model architecture that may be employed herein, is provided by Vaswani et al. in the paper (cited in the Raffel et al. paper mentioned above) entitled “Attention Is All You Need,” Advances in Neural Information Processing Systems, 2017. This paper is hereby incorporated by reference in its entirety for purposes of its disclosed features, systems, processes, and algorithms.

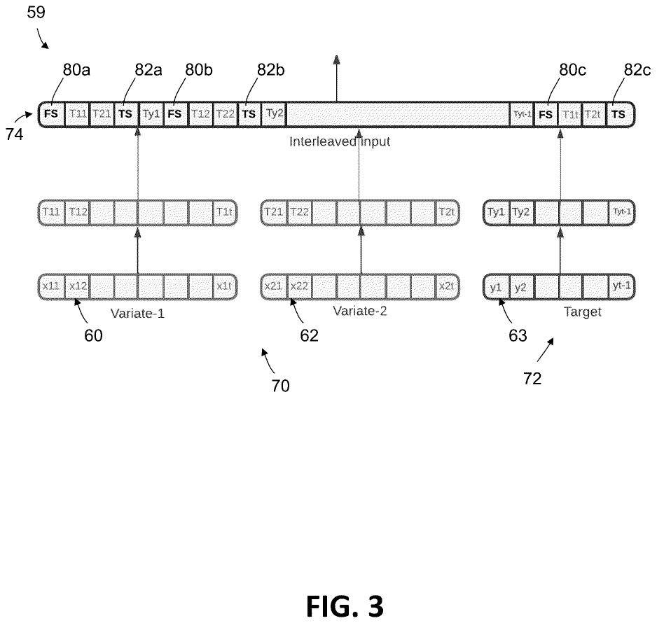

Per more specific embodiments, for example, as described more fully below with reference to FIG. 3, interleaver 34 may be configured so that the separator tokens comprise at least one separator token inserted into the flattened series associated with one or more of the feature model space tokens and at least one target separator token inserted in the flattened series associated with one or more of the given target model space tokens.

More specifically, the separator tokens may comprise at least one separator token inserted into the flattened series before (or immediately before) one or more of the feature model space tokens. At least one target separator token is inserted in the flattened series before (or immediately before) one or more of the given target model space tokens.

By way of example, the feature model space tokens may be arranged together, with no interspersed target model or other model space tokens (or any other interspersed payload data in a feature model space token tuple. In another example, the given target model space tokens may be arranged together, with no interspersed feature model space tokens or other model space tokens (or any other interspersed payload data) in a target model space token tuple.

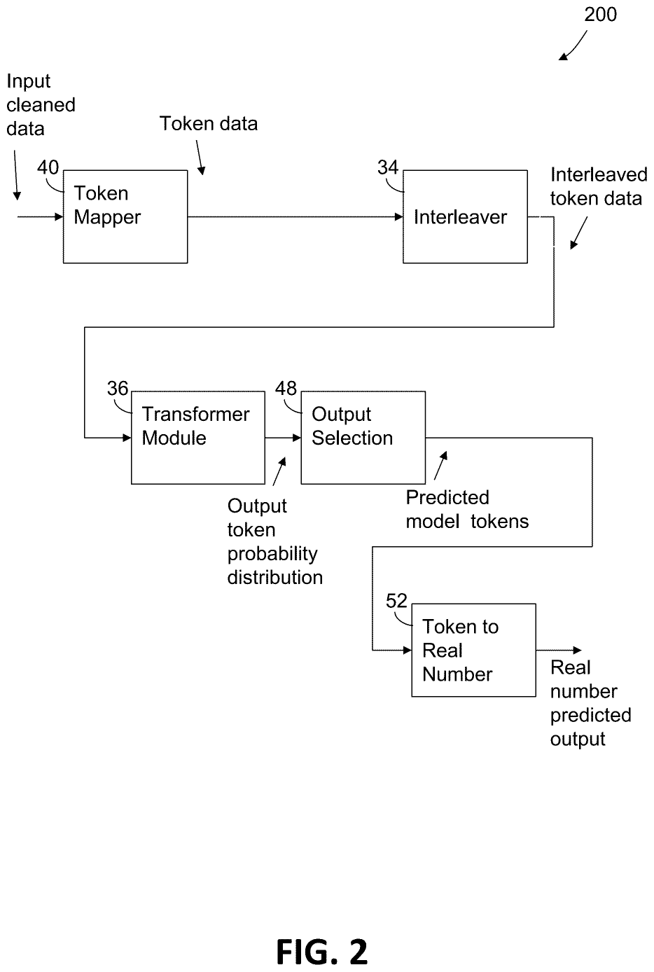

FIG. 2 is a block diagram of an example of how predictive model system 200 may be implemented in more detail, per one embodiment. The illustrated system 200 includes, connected in tandem, a token mapper 40, an interleaver 34, a transformer module 36, an output selection processing circuit 48, and a token to-real number mapper 52.

In operation, the illustrated token mapper 40 receives cleaned data as an input and performs scaling and quantization. The token mapper 40 outputs token data. The token data is then input to interleaver 34. Interleaver 34 outputs interleaved token data which is input to transformer module 36. Transformer module 36 outputs an output token probability distribution which may comprise a tuple of probability values indicating probability values and values identifying associated target values.

Output selection processing circuit 48 then selects and outputs a target value (or respective target values forming a set of target values) with the highest associated probability (or probabilities) as indicated by the probability values. Model to output token mapper 50 then maps the one or more selected (predicted) model token to real number values that are the output of the model system 200.

A token is an alternate representation of the original time series. Each data point in the feature or target series is mapped to a unique token using the quantization technique following the details in “Chronos: Learning the Language of Time Series” paper mentioned in [0046 ].

The embodiments herein may use a tokenization method and assigns numerical values to the tokens. For example, a given time series with 3 values 1.1, 1.2, 1.3 can be mapped to 3 token 101, 102, 103 that are then used by the model for downstream processing. The token values inherently do not have any particular importance. They are just some identifiers that the model can use for downstream processing. If we replace the token for 1.2 as 300 and train the model from scratch, it will perform the same way as when the value 1.2 is mapped to any other token.

FIG. 3 shows, by way of example, a given set of features 60, 62, and an associated target 63. Other embodiments may involve a different number of features for the given set, and more than one associated target. Each of the illustrated features, namely first feature 60, second feature 62, and associated target 63 is in the form of a tuple of input token values. In the embodiments, the input token values are numerical values. The values in features 60, 62 and target 63 are floating point or real numbers. They are converted to tokens which are integers. Given a feature or target data with real numbers, the tokenizer converts them into integer token data by following the quantization technique specified in the “Chronos: Learning the Language of Time Series” paper mentioned above.

The t feature tokens and t-1 target tokens are used to predict the target token at “t”. The missing target value at “t” is exactly what the model is predicting, so it is not present in the input.

FIG. 3 shows, by way of example, first and second features 60 and 62 and a corresponding associated target 63. Model space token values from these features are interleaved into an interleaved input tuple 74 (a flattened series).

After mapping by token mapper 40, the given feature token values x11-x1t (first feature) and x21-x2t (second feature) of the given plural set of features and the given token vector values y1-yt-1 (target vector(s)) are now represented by model space tokens T11-T1t, T21-T2t, and y1-yt-1. These values now are interleaved, whereby early feature tokens T11 and T21 of the feature vectors are placed in the interleaved output 74 near each other (adjacently in the embodiment) and followed by a corresponding early target token Ty1.

Next, feature tokens T12 and T22 are placed in the interleaved output 74 at a next downstream location in the tuple, followed by a corresponding next target token Ty2. This is repeated for ensuing feature tokens and corresponding target tokens until the last feature tokens T1t and T2t are placed in interleaved input tuple 74.

At least one feature separator token FS 80 is inserted into the flattened series (interleaved input) 74 at a location associated with (indicating) one or more of the feature model space tokens. In addition, at least one target separator token TS 82 is inserted into the flattened series 74 at a location associated with (indicating) one or more target model space tokens.

In the embodiment illustrated, a feature separator token FS 80a, 80b, 80c is inserted before each interleaved set of feature model space tokens. As shown, these interleaved sets are sets of two (corresponding to the number of features in this example) feature model space tokens T11, T21 (following feature separator token 80a), two feature model space tokens T12, T22 (following feature separator token 80b), and so on until the last two feature model space tokens T1t, T2t (following feature separator token 80c).

In the embodiment illustrated, a target separator token TS 82a, 82b, 82c is inserted before each target model space token (or interleaved set of target model space tokens). As shown, these are target model space token Ty1 (following target separator token 82a), target model space token Ty2 (following target separator token 82b), and so on until the last target model space token Tyt-1 (following target separator token 82c).

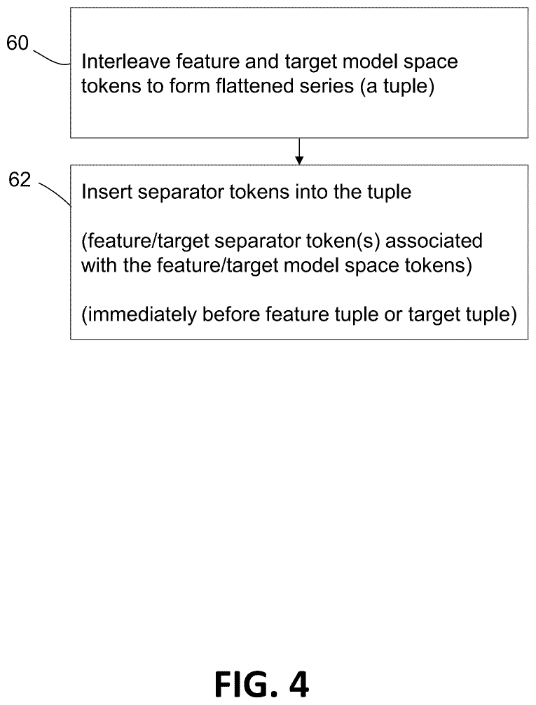

FIG. 4 is a flowchart showing one example embodiment of the above-described process for interleaving. In block 60, the feature and target model space tokens are interleaved to form the flattened series. Then, in block 62, separator tokens are inserted into the tuple, in the manner described above.

The TS indicates to the model that the next token is a target token (until the model encounters a FS). For example, if there are 2 features and 3 targets in a prediction problem, TS will be followed by 3 target tokens followed by FS. Similarly, FS indicates that the next few tokens until TS are feature tokens. These special tokens TS and FS provide the model additional information on features and targets. In the illustrated embodiment, the input sequence is ended with TS, so that the model can predict the targets which follow the TS token. By ending the input sequence with TS, the model is able to predict the target tokens.

The illustrated input sequence of tokens 74 is mapped to a sequence of embeddings, which is then passed into an encoder which may comprise a stack of blocks of the transformer system 200, each of which comprises two subcomponents: a self-attention layer followed by a small feed-forward network.

In one embodiment, special token values may represent feature separator (FS) and target separator (TS). For example, a −14.00 float value may be used as a token for FS, and a 14.00 float value may represent TS. These are fixed at the beginning of the training and explicitly not used to represent any feature or target values.

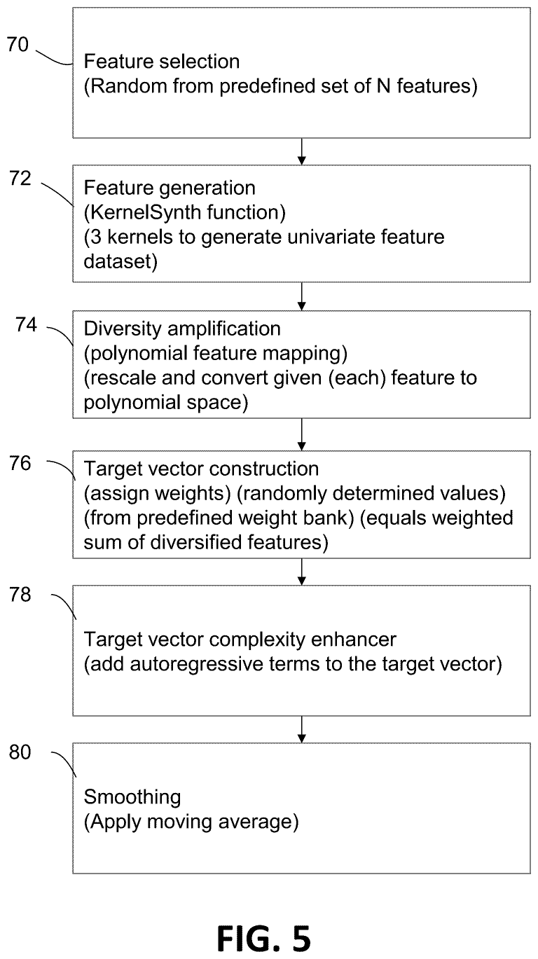

FIG. 5 is a flowchart of an example embodiment of a data generation process, carried out, for example, by data generation processing circuit 14 shown in FIG. 1. In block 70, a given plural set of features is selected. In this step we select the number of features to be used rather than features itself. Hence, we sample an integer from 1 to N, say k, and use k features as out input features and target feature as a function of these k features

In block 72, features are generated, meaning that univariate data feature data is generated from each given feature from the plural set. a KernelSynth data generator may be used for this purpose, which may be configured for a maximum number of kernels. Per one example, the maximum number is three. The KernelSynth generator may be as described by Ansari et al. in the paper entitled “Chronos: Learning the Language of Time Series”, published in Transactions on Machine Learning Research (10/2024). This paper is hereby incorporated by reference herein in its entirety for purposes of its disclosed features, systems, processes, and algorithms.

In block 74, diversified features are created by revising the generated univariate feature data for a given feature from the plural set. The revision includes adding nonlinearity. A polynomial mapper may be provided that is configured to map a polynomial function with a given maximum degree (e.g., of 3) to each feature in the plural set, thereby rescaling and converting each feature to polynomial space.

In block 76, target vectors are constructed. One or more target vectors may be provided that are associated with the given plural set of features. More specifically, the target vector may comprise a weighted sum of the diversified features. Weights may be assigned and may vary with time. The weights may include randomly determined values, for example, from a predefined weight bank. Per one embodiment, the vector equals the weighted sum of the diversified features.

Per block 78, the complexity of the target vector may be enhanced, by adding complexity to one or more of the target vectors. This may involve an autoregressive term adder configured to add autoregressive terms to the one or more target vectors, wherein the autoregressive terms simulate temporal patterns.

Per block 80, smoothing may be applied to one or more target vectors. This may be done with a moving averager.

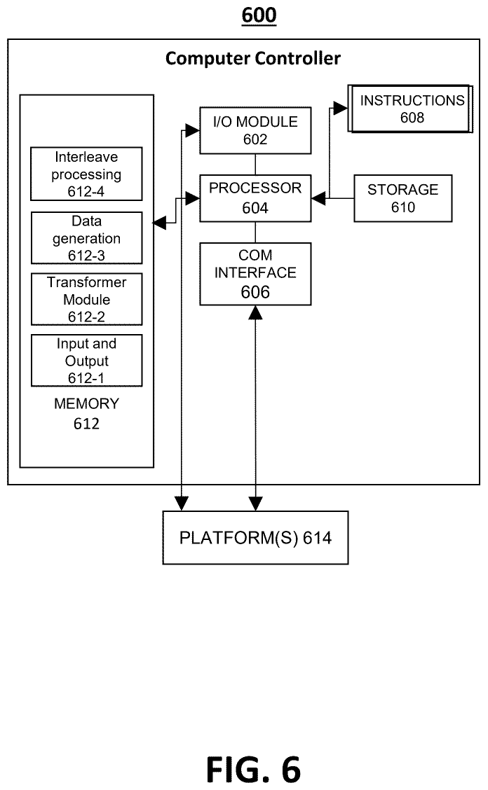

FIG. 6 illustrates, in accordance with one or more other exemplary embodiments, a computer controller 600 that may be an application-specific hardware, software, and/or firmware implementation of one or more parts of the system 10 in FIG. 1, described above. The controller 600 may include a processor 604 configured to be executed on one or more, or all of the blocks of the system of FIG. 1, or the functions of the system of FIG. 1 or the process of FIG. 2, described above.

The processor 604 can have a specific structure imparted to the processor 604 by instructions stored in the memory 112 and/or by instructions 608 fetchable by the processor 604 from a storage medium 610. The storage medium 610 can be remote and communicatively coupled to the controller 600.

The controller 600 can be a stand-alone programmable system, or a programmable module included in a larger system. For example, the controller 600 may include or be connected with the secure online processing system 50. For example, the controller 600 may include one or more hardware and/or software components configured to fetch, decode, execute, store, analyze, distribute, evaluate, and/or categorize information.

The processor 604 may include one or more processing devices or cores (not shown). In some embodiments, the processor 604 may be a plurality of processors, each having one or more cores. The processor 604, in another embodiment, may be a distributed processor. The processor 604 can execute instructions fetched from the memory 612, i.e., with reference to, among other code, instructions or data, one of memory modules 612-1, 612-2, 612-3, or 612-4. Alternatively, the instructions can be fetched from the storage medium 610, or from a remote device connected to the controller 600 via the communication interface 606. Furthermore, the communication interface 606 can also interface with computer systems within a computer system of one or more parts of the system 10. An input/output (I/O) module 602 may be configured for additional communications to or from associated local and/or remote systems of one or more platforms 614 of system 10.

Without loss of generality, the storage medium 610 and/or the memory 112 can include a volatile or non-volatile, magnetic, semiconductor, tape, optical, removable, non-removable, read-only, random-access, or any type of non-transitory computer-readable computer medium. The storage medium 610 and/or the memory 612 may include programs and/or other information usable by processor 604. Furthermore, the storage medium 610 can be configured to log data processed, recorded, or collected during the operation of controller 600.

The data may be time-stamped, location-stamped, cataloged, indexed, encrypted, and/or organized in a variety of ways consistent with data storage practice. The memory modules in memory 612 may represent specialized modules for various functions described in the embodiments herein. By way of example, the memory module 612-1 may represent a specialized module configured to implement aspects of the input and output processing described above. Similarly, the memory module 612-2 may form a transformer module as described above, the memory module 112-3 may form a specialized data generation module as described above, and the memory module 112-4 may form an interleave processing module as described above. The instructions embodied in these memory modules can cause the processor 604 to perform certain operations consistent with the functions described above.

The list of advantages described above is not exhaustive and other possibilities are also compatible with the present disclosure. Many features and advantages of the present disclosure are disclosed in the detailed specification.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

While the foregoing is directed to embodiments of the present disclosure, other and further embodiments of the disclosure may be devised without departing from the basic scope thereof, and the scope thereof is determined by the claims that follow.

What is claimed is:

1. Apparatus comprising:
a feature selection processing circuit configured to select a given plural set of features;
a feature generator configured to generate univariate feature data for a given feature from the plural set; and
a target vector constructor configured to provide one or more target vectors associated with the given plural set of features.

2. The apparatus according to claim 1, wherein the feature selection processing circuit is configured to randomly select the given plural set.

3. The apparatus according to claim 2, wherein the feature selection processing circuit is configured to select from a predefined set.

4. The apparatus according to claim 1, wherein the feature generator is configured to generate univariate feature data for each feature from the plural set.

5. The apparatus according to claim 1, wherein the feature generator comprises a KernelSynth data generator.

6. The apparatus according to claim 5, wherein the KernelSynth data generator is configured with a given maximum number of kernels.

7. The apparatus according to claim 1, further comprising a diversity amplifier configured to create diversified features by revising the generated univariate feature data for each feature from the plural set, wherein the revision includes adding nonlinearity.

8. The apparatus according to claim 7, wherein the diversity amplifier comprises a polynomial mapper configured to map a polynomial function with a given maximum degree to each feature in the plural set, thereby rescaling and converting each feature to polynomial space.

9. The apparatus according to claim 1, wherein the target vector constructor comprises a weighted sum of the diversified features.

10. The apparatus according to claim 1, further comprising a target vector complexity enhancer configured to add complexity to the one or more target vectors.

11. The apparatus according to claim 10, wherein the target vector complexity enhancer comprises an autoregressive term adder configured to add autoregressive terms to the one or more target vectors, wherein the autoregressive terms simulate temporal patterns.

12. The apparatus according to claim 1, further comprising a smoother configured to smooth the one or more target vectors.

13. The apparatus according to claim 12, wherein the smoother comprises a moving averager.

14. Apparatus comprising:
storage encoded with a given set of features and one or more target vectors associated with and related to the given set of features, based on time-series data;
a prediction model comprising a transformer module to perform time-series forecasting with tokenization;
an input processing circuit comprising an interleaver configured to interleave feature and target model space tokens representing and converted from the given plural set of features and the given one or more target vectors, with separator tokens to form a flattened series of tokens, wherein the input processing circuit is configured to input the flattened series of tokens to the transformer module; and
an output processing circuit configured to select a given one or more predicted target model tokens from an output token probability distribution output by the transformer module.

15. The apparatus according to claim 14, wherein the transformer module comprises encoder and decoder stacks.

16. The apparatus according to claim 15, wherein the transformer module comprises a T5 transformer.

17. The apparatus according to claim 16, wherein the transformer module comprises a T5-small transformer.

18. The apparatus according to claim 15, wherein the separator tokens comprise at least one feature separator token inserted in the flattened series at a location associated with one or more of the feature model space tokens and at least one target separator token inserted in the flattened series at a location associated with one or more of the given target model space tokens.

19. The apparatus according to claim 18, wherein the one or more feature model space tokens comprise a feature tuple.

20. The apparatus according to claim 18, wherein the one or more target model space tokens comprise a target tuple.

21. A method comprising:
encoding storage with a given set of features and one or more target vectors associated with and related to the given set of features, based on time-series data;
operating a prediction model comprising a transformer module to perform time-series forecasting with tokenization;
performing input processing comprising interleaving feature and target model space tokens representing and converted from the given plural set of features and the one or more target vectors, with separator tokens to form a flattened series of tokens, wherein the flattened series of tokens is input to the transformer module; and
performing output processing comprising selecting a given one or more predicted target model tokens from an output token probability distribution output by the transformer module.

22. The method according to claim 21, wherein the operated transformer module comprises encoder and decoder stacks.

23. The method according to claim 22, wherein the operated transformer module comprises a T5 transformer.

24. The method according to claim 23, wherein the operated transformer module comprises a T5-small transformer.

25. The method according to claim 22, wherein the separator tokens comprise at least one feature separator token inserted in the flattened series at a location associated with one or more of the feature model space tokens and at least one target separator token inserted in the flattened series at a location associated with one or more of the given target model space tokens.

26. The method according to claim 25, wherein the one or more feature model space tokens comprise a feature tuple.

27. The method according to claim 25, wherein the one or more target model space tokens comprise a target tuple.

28. Non-transitory computer-readable media, encoded to cause:
encoding storage with a given set of features and one or more target vectors associated with and related to the given set of features, based on time-series data;
operating a prediction model comprising a transformer module to perform time-series forecasting with tokenization;
performing input processing comprising interleaving feature and target model space tokens representing and converted from the given plural set of features and the one or more target vectors, with separator tokens to form a flattened series of tokens, wherein the flattened series of tokens is input to the transformer module; and
performing output processing comprising selecting a given one or more predicted target model tokens from an output token probability distribution output by the transformer module.

29. The media according to claim 28, wherein the operated transformer module comprises encoder and decoder stacks.

30. The media according to claim 29, wherein the operated transformer module comprises a T5 transformer.

31. The method according to claim 30, wherein the operated transformer module comprises a T5-small transformer.

32. The method according to claim 29, wherein the separator tokens comprise at least one feature separator token inserted in the flattened series at a location associated with one or more of the feature model space tokens and at least one target separator token inserted in the flattened series at a location associated with one or more of the given target model space tokens.

33. The method according to claim 32, wherein the one or more feature model space tokens comprise a feature tuple.
